(19) United States
(12) Patent Application Publication
(10) Pub. No.: US 2013/0170135 A1
(43) Pub. Date: Jul. 4, 2013

(54) AIRFLOW GUIDE MEMBER AND ELECTRONIC DEVICE HAVING THE SAME

(71) Applicant: XIAO-FENG MA, Shenzhen City (CN)

(72) Inventor: XIAO-FENG MA, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/463,826

(22) Filed: May 4, 2012

(30) Foreign Application Priority Data
Dec. 29, 2011 (CN) 201110450095.3

(51) Int. Cl. G06F 1/20; F24F 7/00

(52) U.S. Cl. 361/679.51; 454/284

(57) ABSTRACT

An airflow guide member includes a base, a top plate, and at least one resilient plate. Two rows of stop tabs are formed on a top surface of the base respectively adjacent to front and rear sides of the base. Two rows of stop tabs are formed on a bottom surface of the top plate respectively adjacent to front and rear sides of the top plate. A slot is bounded by every two adjacent stop tabs. Front ends of a top and a bottom of each resilient plate are selectively inserted into two slots respectively at the front sides of the top plate and the base, and rear ends of the top and the bottom of each resilient plate are selectively inserted into two slots respectively at the rear sides of the top plate and the base. The resilient plate can be adjusted to direct air to different directions.

### BACKGROUND

1. Technical Field

The present disclosure relates to an airflow guide member and an electronic device having the airflow guide member.

2. Description of Related Art

Fans and airflow guide members are usually mounted in an electronic device to direct air from outside into the electronic device, to cool a plurality of electronic components on a motherboard mounted in the electronic device. However, sometimes, there is a need to move the fan or change the airflow guide member in order to adjust the direction of the airflow according to heat dissipation requirement, which often demands more than a simple maneuver.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an exemplary embodiment of an electronic device.

FIG. 2 is an exploded, isometric view of FIG. 1, wherein the electronic device includes an airflow guide member.

FIG. 3 is an exploded, isometric view of the airflow guide member of FIG. 2, wherein the airflow guide member includes a base, two resilient plates, and a cover.

FIG. 4 is an inverted view of the cover and the resilient plates of FIG. 3.

FIG. 5 is an assembled, isometric view of the resilient plates and the base of FIG. 3.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

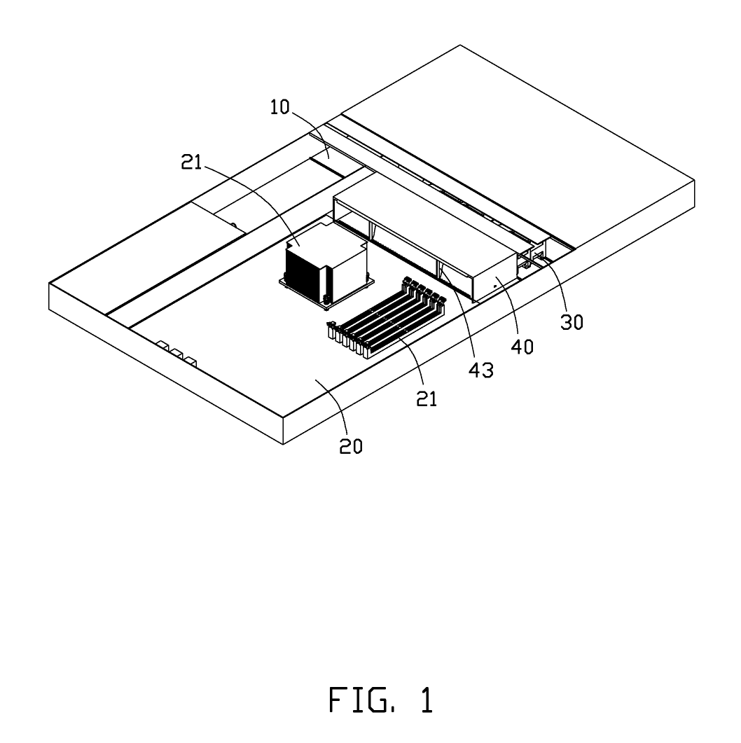

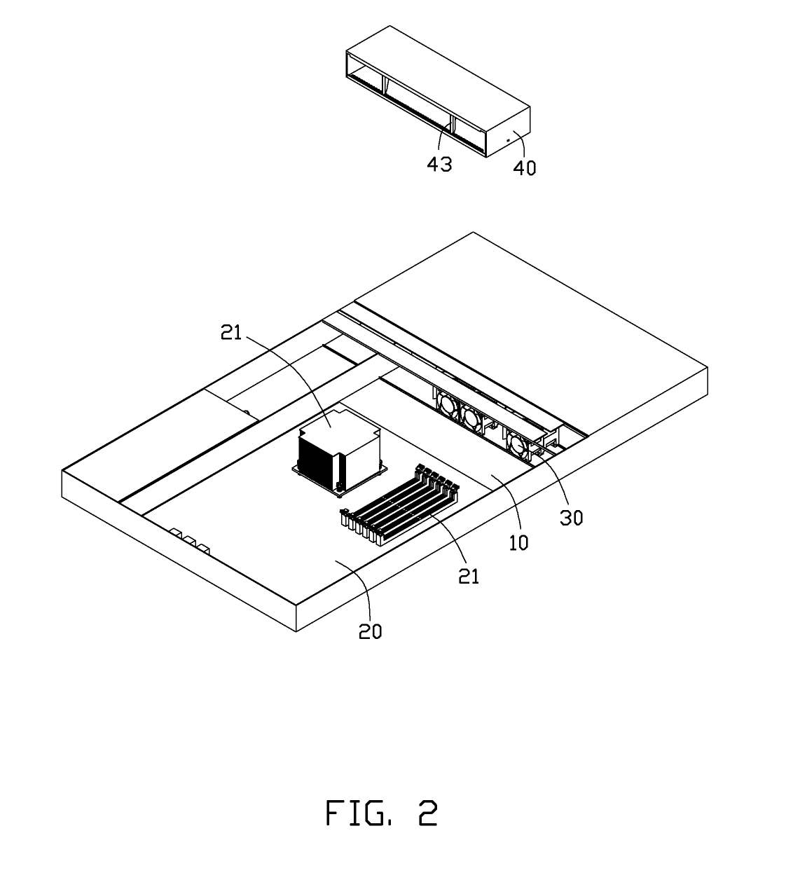

FIGS. 1 and 2 show an exemplary embodiment of an electronic device including a chassis 10, a motherboard 20 mounted in the chassis 10, a plurality of fans 30 mounted in the chassis 10 behind the motherboard 20, and an airflow guide member 40. A plurality of electronic components 21 is mounted on the motherboard 20.

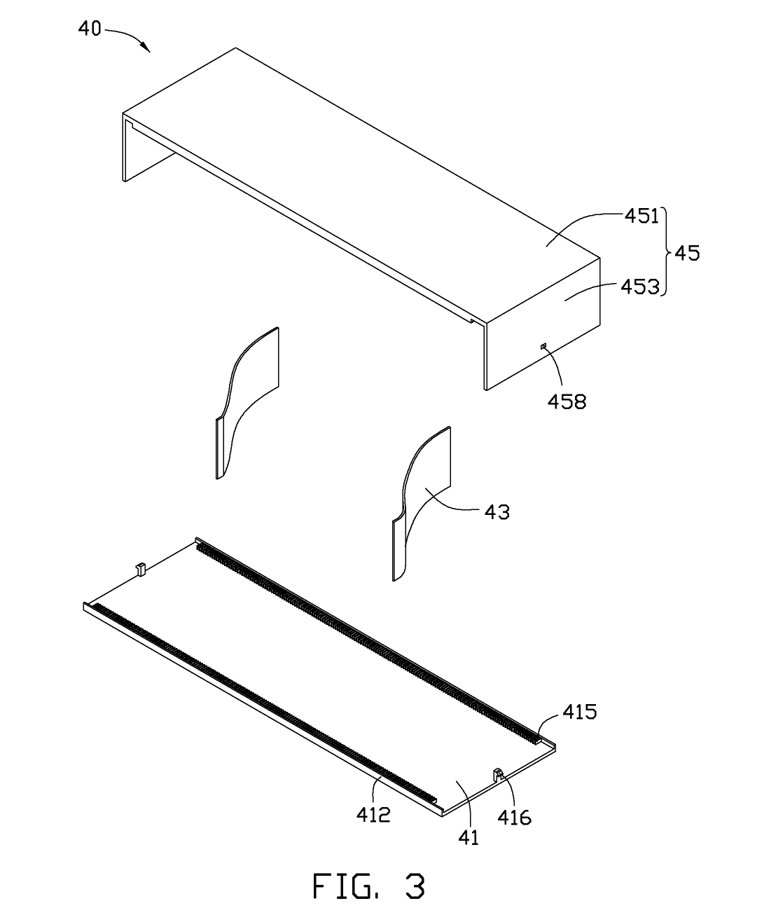

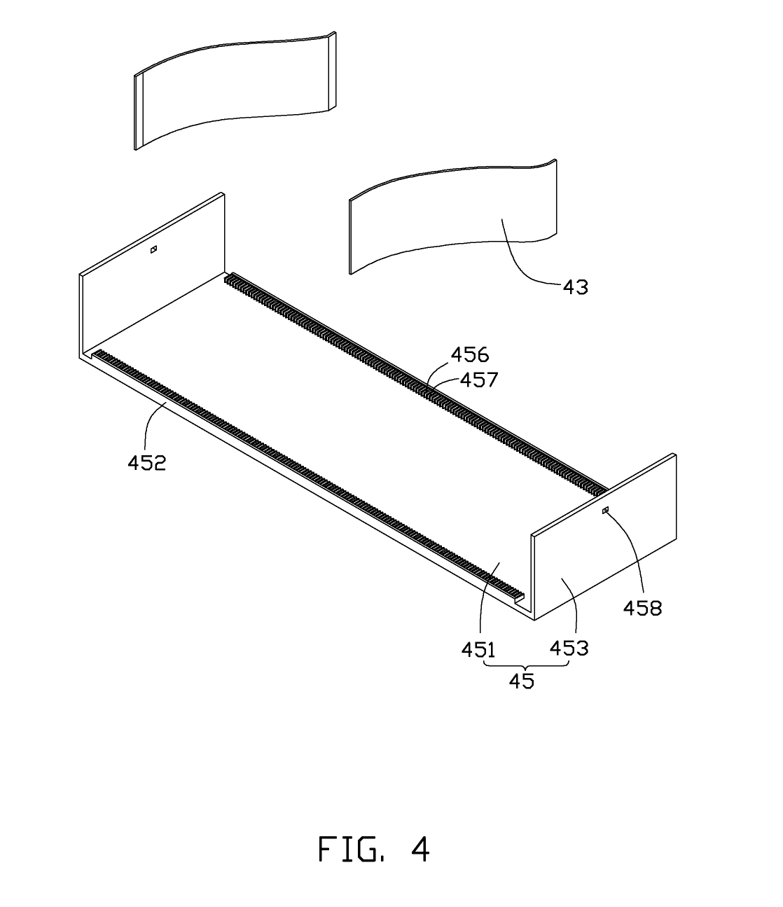

Referring to FIGS. 3 to 5, the airflow guide member 40 includes a substantially rectangular base 41, two resilient plates 43, and a cover 45.

Two flanges 412 respectively extend up from the front and rear sides of the base 41. A plurality of stop tabs 415 arranged in two rows parallel to the flanges 412, are formed on the top surface of the base 41 respectively adjacent to the flanges 412. Each stop tab 415 is perpendicular to the base 41 and the flanges 412. A slot 417 is bounded by every two adjacent ones of the stop tabs 415 of a same row of the two rows of the stop tabs 415. Two out-pointing hooks 416 respectively extend up from opposite ends of the base 41.

The cover 45 includes a substantially rectangular top plate 451 and two end plates 453 respectively extending down from opposite ends of the top plate 451. Two flanges 452 respectively extend down from the front and rear sides of the top plate 451. A plurality of stop tabs 456 arranged in two rows parallel to the flanges 452, are formed on the bottom surface of the top plate 451 respectively adjacent to the flanges 452. Each stop tab 456 is perpendicular to the top plate 451 and the flanges 452. A slot 457 is bounded by every two adjacent stop tabs 456. A latching hole 458 is defined in a lower portion of each end plate 453.

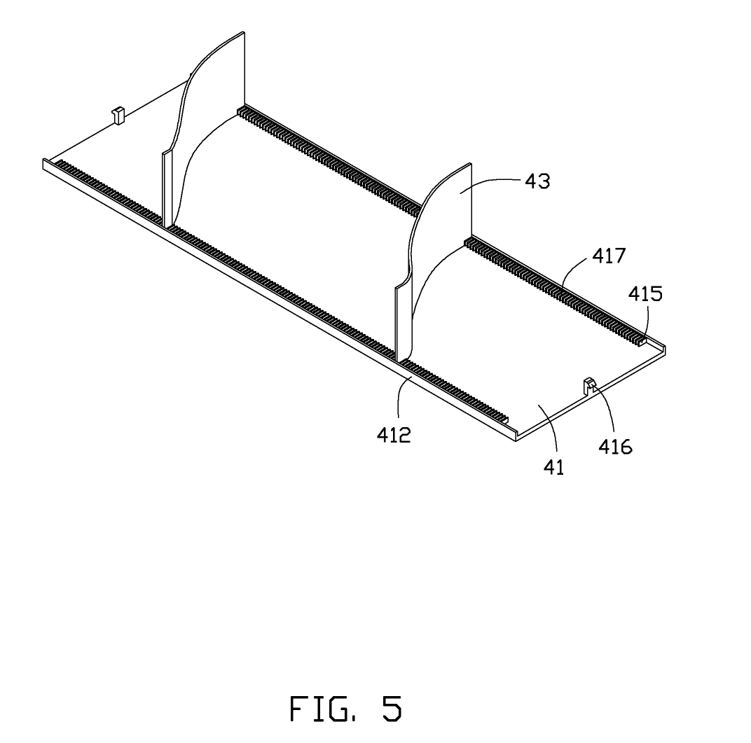

Referring to FIGS. 1 and 5, in assembly, the base 41 is mounted in the chassis 10 between the fans 30 and the motherboard 20, with the flanges 412 respectively adjacent to the fans 30 and the motherboard 20. According to the arrangement of the fans 30, the rear ends of the bottoms of the resilient plates 43 are inserted into two corresponding slots 417 at the rear side of the base 41. According to the arrangement and heat dissipation demands of the electronic components 21 and the motherboard 20, the front ends of the bottoms of the resilient plates 43 can be inserted into two corresponding slots 417 at the front side of the base 41.

The cover 45 is covered on the base 41, to allow the front and rear ends of the top of each resilient plate 43 to be correspondingly inserted into two slots 457 at front and rear sides of the top plate 451. The hooks 416 correspondingly engage in the latching holes 458, to fix the cover 45 to the base 41. Thereby, the resilient plates 43 are substantially perpendicularly fixed between the top plate 451 and the base 41. Opposite ends of the resilient plates 43 are respectively blocked by the flanges 412 and 452.

In use, the fans 30 blow air into the airflow guide member 40, and the air is directed to the electronic components 21 by the guide of the resilient plates 43. To different motherboards 20, the resilient plates 43 can be bent, to make opposite ends of each plate 43 engage in different slots 417 and 457, thereby, the resilient plates 43 can guide air to different direction.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. An airflow guide member, comprising:
a base, and two rows of stop tabs formed on a top surface of the base respectively adjacent to front and rear sides of the base, wherein a slot is bounded by every two adjacent ones of the stop tabs of a same row of the two rows of stop tabs of the base;
a top plate, and two rows of stop tabs formed on a bottom surface of the top plate respectively adjacent to front and rear sides of the top plate, a slot is bounded by every two adjacent ones of the stop tabs of a same row of the two rows of stop tabs of the top plate;
two end plates respectively connected between first ends of the base and the top plate and second ends of the base and the top plate; and
at least one resilient plate, wherein front ends of a top and a bottom of each resilient plate are selectively inserted into two slots respectively at the front sides of the top plate and the base, and rear ends of the top and the bottom of each resilient plate are selectively inserted into two slots respectively at the rear sides of the top plate and the base.

2. The airflow guide member of claim 1, wherein the end plates respectively extend down from the first and second ends of the top plate, a latching hole is defined in a lower portion of each end plate, two hooks respectively extend up from the first and second ends of the base, to respectively engage in the latching holes.

3. The airflow guide member of claim 1, wherein two flanges respectively extend up from the front and rear sides of the base, and two flanges respectively extend down from the front and rear sides of the top plate, front and rear ends of said at least one resilient plate are respectively blocked by the flanges of the base and the top plate.

4. The airflow guide member of claim 3, wherein each row of stop tabs is arranged parallel to the flanges, and each stop tab is perpendicular to the flanges.

5. An electronic device, comprising:
a chassis;
a motherboard mounted in the chassis, wherein a plurality of electronic components is mounted on the motherboard;
at least one fan mounted in the chassis behind the motherboard; and
an airflow guide member mounted in the chassis between the motherboard and said at least one fan, the airflow guide member comprising:
a base, and two rows of stop tabs formed on a top surface of the base respectively adjacent to front and rear sides of the base, wherein a slot is bounded by every two adjacent ones of the stop tabs of a same row of the two rows of stop tabs of the base;
a cover detachably covered on the base and comprising a top plate and two rows of stop tabs formed on a bottom surface of the top plate respectively adjacent to front and rear sides of the top plate, wherein a slot is bounded by every two adjacent ones of the stop tabs of a same row of the two rows of stop tabs of the top plate; and
at least one resilient plate, wherein front ends of a top and a bottom of each resilient plate are selectively inserted into two slots respectively at the front sides of the top plate and the base, and rear ends of the top and the bottom of each resilient plate are selectively inserted into two slots respectively at the rear sides of the top plate and the base, said at least one fan blows air into the airflow guide member and the air is directed to the electronic components by guides of said at least one resilient plate.

6. The electronic device of claim 5, wherein the cover further comprises two end plates respectively extending down from opposite ends of the top plate, a latching hole is defined in a lower portion of each end plate, two hooks respectively extend up from opposite ends of the base, to respectively engage in the latching holes.

7. The electronic device of claim 5, wherein two flanges respectively extend up from the front and rear sides of the base, and two flanges respectively extend down from the front and rear sides of the top plate, front and rear ends of said at least one resilient plate are respectively blocked by the flanges of the base and the top plate.

8. The electronic device of claim 7, wherein each row of stop tabs is arranged parallel to the flanges, and each stop tab is perpendicular to the flanges.
